(19) United States
(12) Patent Application Publication
(10) Pub. No.: US 2019/0168422 A1
(43) Pub. Date: Jun. 6, 2019

(54) DEVICE AND METHOD FOR THE JOINT FEEDING OF PLASTIC PARTICLES AND A LIQUID INTO A PURIFICATION DEVICE

(71) Applicant: CVP Clean Value Plastics GmbH, Hamburg (DE)

(72) Inventors: Michael Hofmann, Hamburg (DE); Dirk Schneider, Buxtehude (DE)

(73) Assignee: CVP Clean Value Plastics GmbH, Hamburg (DE)

(21) Appl. No.: 16/082,115

(22) PCT Filed: Feb. 22, 2017
(86) PCT No.: PCT/EP2017/054006

§ 371 Date: Feb. 19, 2019

(30) Foreign Application Priority Data
Mar. 3, 2016 (DE) 10 2016 103 781.8

(51) Int. Cl. B29B 17/02; B01F 5/00; B01F 3/12; B08B 3/04; B08B 3/02; B08B 3/10

(52) U.S. Cl. CPC B29B 17/02; B01F 5/0062; B01F 3/12; B29B 2017/0289; B08B 3/022; B08B 3/102; B08B 3/04

(57) ABSTRACT

A device for jointly delivering plastic particles and a liquid to a cleaning device to remove impurities from the plastic particles comprises a delivery funnel comprising an inlet and an outlet, wherein the inlet is configured to connect to a supply for the plastic particles, and the outlet is configured to connect to the cleaning device. At least one delivery nozzle is positioned on the delivery funnel and is configure to connect to a liquid supply. The at least one delivery nozzle is configured to discharge at least one liquid jet into the delivery funnel, wherein a position of the at least one delivery nozzle promotes mixing of the supplied plastic particles and the liquid in the delivery funnel.

### CROSS REFERENCE TO RELATED INVENTION

This application is a national stage application pursuant to 35 U.S.C. § 371 of International Application No. PCT/EP2017/054006, filed on Feb. 22, 2017, which claims priority to, and benefit of, German Patent Application No. 10 2016 103 781.8, filed Mar. 3, 2016, the entire contents of which are hereby incorporated by reference.

### BACKGROUND

The invention relates to a device for jointly delivering plastic particles and a liquid to a cleaning device to remove impurities from the plastic particles. The invention also relates to a method for jointly delivering plastic particles and a liquid to a cleaning device to remove impurities from the plastic particles.

Cleaning devices for removing impurities from plastic particles, in particular from plastic flakes, are for example known from WO 2013/010654 A2 or WO 2014/111412 A1. To clean the plastic particles, they are introduced together with a liquid, generally water, into the processing region of the cleaning device.

There are basically two versions of known delivery methods. On the one hand, it is known to stir the plastic particles into water in a separate container and pump the suspension through the cleaning device by means of a solids pump. A disadvantage in this context is that a comparatively large stirring container with a correspondingly involved agitator is needed. Moreover, the produced suspension must be pumpable so that a comparatively large amount of water is necessary. This in turn eventuates in a high energy requirement by the cleaning device since a large amount of water must be accelerated. Moreover, a solids pump between the stirring tank and cleaning device is necessary. It is alternatively known to add the plastic particles by means of a stuffing screw and supply water, either to the stuffing screw or to the cleaning device. However, it is revealed in practice that at present, no satisfactory technical solution exists for delivering film particles (plastic flakes) to the cleaning device. Screw deliveries have a natural output limit due to the low bulk density of plastic flakes and the geometric boundary conditions. This output limit lies below the potential capacity of the cleaning devices so that they cannot be optimally exploited. Moreover, continuously supplying plastic particles to the stuffing screw, and hence to continuously supplying the cleaning devices is difficult in practice.

### BRIEF SUMMARY OF THE INVENTION

Proceeding from the described prior art, the object of the invention is therefore to provide a device and a method of the aforementioned type by means of which the cleaning device can be supplied a precisely-dosed mixture of plastic particles and liquid in an easy and energy-efficient manner.

The invention achieves the object for a device of the aforementioned type by means of a delivery funnel whose inlet is connected to a supply for the plastic particles, and whose outlet is connected via a supply line to an inlet of the cleaning device, wherein at least one delivery nozzle connected to a liquid supply is arranged on the delivery funnel and through which at least one liquid jet is discharged into the delivery funnel, wherein the at least one delivery nozzle is arranged such that a mixture occurs in the delivery funnel of the plastic particles supplied to the delivery funnel with the liquid.

For a method of the aforementioned type, the invention achieves the object in that plastic particles are supplied to the inlet of a delivery funnel, wherein by means of at least one delivery nozzle connected to a liquid supply, at least one liquid jet is discharged into the delivery funnel such that a mixture occurs in the delivery funnel of the plastic particles supplied to the delivery funnel with the liquid, and wherein the mixture of the plastic particles and the liquid is supplied via an outlet of the delivery funnel to an inlet of the cleaning device.

The plastic particles are cleaned in the cleaning device during a recycling process. They can for example be comminuted plastic beverage bottles, or other comminuted plastic products. The plastic particles can for example be PET plastic particles. Other materials are also possible. In the cleaning device, impurities are removed from the plastic particles. The cleaning device can be a so-called refiner in which the impurities are rubbed off of the plastic particles. The refiner can be a disk refiner with two cleaning discs that oppose each other, between which the plastic particles are cleaned, in particular by friction. It can however also be a drum, or respectively ball refiner. The impurities are in particular adhesions to the plastic particles such as cellulose residue, adhesive residue, label residue or organic contaminants. The plastic particles can be plastic particles with a low bulk density, in particular shredded plastic, or respectively flat pieces of film (plastic flakes). The plastic particles can however also be plastic particles with a greater bulk density such as granulate plastic, in particular granular hard plastics.

The device according to the invention comprises a delivery funnel with an inlet that is supplied with the plastic particles, in particular separately. At least one delivery nozzle is provided on the delivery funnel. The at least one delivery nozzle is connected to a liquid supply, for example via a pump. The liquid to be supplied to the cleaning device together with the plastic particles is conducted into the delivery funnel through the at least one delivery nozzle. The liquid discharged into the delivery funnel can for example be water. Correspondingly, the liquid supply can be a water supply. The plastic particles fall from above, in particular under gravity, into the delivery funnel and are captured by the liquid discharged by the at least one delivery nozzle. The outlet of the delivery funnel is for example connected via a pipeline to an inlet of the cleaning device, such as a refiner.

The at least one delivery nozzle is arranged according to the invention such that a mixture occurs in the delivery funnel of the plastic particles supplied to the delivery funnel with the liquid. By the even mixture according to the invention of the plastic particles supplied to the delivery funnel with the liquid, an optimum delivery of the plastic particles to the cleaning device occurs. A mixing zone is thus formed in the region of the funnel outlet. A suspension consisting of the liquid and the plastic particles with a nearly constant solid component is consequently supplied to the inlet of the cleaning device.

A precise and even dosing of the plastic particles into the liquid is achieved by the invention in a simple and energy-efficient manner. In this context, the plastic component in the liquid/plastic mixture can be increased over the prior art. Especially in a highly consistent mode of operation, fluctuations in the dosing can very quickly lead to clogging and therefore interruptions in operation. Due to the reliably precise adjustment of the solid component according to the invention, this can be avoided. A precise and a targeted supply of liquid to the delivery funnel is enabled by the at least one delivery nozzle. The liquid supply is thereby optimized, possibly while exploiting the kinetic energy of the liquid. A reliable mixing zone of liquid and plastic particles is formed that is also configured for high outputs. The mixing zone can lie particularly close to the inlet of the cleaning device, only spaced by the connecting line between the funnel outlet and the inlet of the cleaning device. In addition, the invention is universally useful, i.e., inter alia for (granular) hard plastics.

Since the solid component, as explained, can be increased relative to the prior art, the consumption of liquid is comparatively lowered. Accordingly, less liquid must be recycled after the cleaning process. The energy efficiency is improved. Moreover, the throughput is increased with a sub-proportional increase in required energy. The operational reliability is also increased.

The at least one delivery nozzle can also be arranged according to one embodiment such that a swirl that mixes the plastic particles supplied to the delivery funnel with the liquid is formed in the region of the outlet of the delivery funnel. Since a liquid swirl, or respectively liquid vortex is formed in the region of the funnel outlet, the even mixture of the plastic particles with the supplied liquid is further optimized. The dosing of the plastic particles can thereby be further homogenized, and the efficiency and operational reliability of the invention can be further increased.

According to another particularly practical embodiment, the liquid jet discharged by the at least one delivery nozzle can be directed toward the inner wall of the delivery funnel, preferably at an angle relative to the axial direction of the delivery funnel. In this manner, a swirl can be very easily generated in the funnel outlet. In this case, the axial direction of the funnel is formed by the middle axis running between the funnel inlet and the funnel outlet. The angle of the liquid jet relative to this axial direction can in particular be greater than 45°. It can for example lie within a range of 50° to 80°, preferably within a range of 60° to 70°.

At least one delivery nozzle can be arranged on the edge of the inlet of the delivery funnel according to another embodiment. In this case, the at least one delivery nozzle can penetrate the wall of the delivery funnel in the region of the opening edge of the delivery funnel so that a supply line coming from the liquid supply from the outside can be connected to the at least one delivery nozzle.

The alignment of the at least one delivery nozzle can be adjustable according to another embodiment, for example, manually or controlled by an adjusting apparatus. The invention can thereby be adapted to different operating situations.

According to another embodiment, a plurality of delivery nozzles connected to a liquid supply can be arranged on the delivery funnel, through which the liquid is supplied to the delivery funnel. The plurality of delivery nozzles can then also be arranged such that a swirl that mixes the plastic particles with the liquid is formed in the region of the outlet of the funnel. Correspondingly, the liquid jets discharged from the plurality of delivery nozzles can then be directed toward the inner wall of the delivery funnel, for example at an angle relative to the axial direction of the delivery funnel as explained above, in particular at the same angle relative to the axial direction of the delivery funnel. The liquid jets discharged by the delivery nozzles can also be directed parallel or at a (in particular the same) slight angle (for example less than 20°, preferably less than 10°) to a tangent touching the opening edge of the funnel inlet in the region of the attachment of the delivery nozzles. The liquid discharged by the delivery nozzles then runs helically downward on the inner wall of the delivery funnel to the outlet and forms a swirl there. Likewise, the plurality of the delivery nozzles can be arranged on the edge of the funnel inlet. The position of the plurality of delivery nozzles can also be adjustable. The number of necessary delivery nozzles according to the invention depends on the respective application. It is in principle conceivable to only use one delivery nozzle. In practice however a plurality of delivery nozzles would probably be useful, for example at least four or more than four delivery nozzles.

Moreover at least one delivery nozzle can be arranged on the delivery funnel through which a directed liquid jet is discharged directly into the outlet of the delivery funnel. Or a plurality of such delivery nozzles can be provided. The at least one delivery nozzle then functions as at least one rinsing nozzle. It can for example be arranged vertically above the outlet of the delivery funnel so that the discharged liquid jet is directed in an axial direction of the delivery funnel into the funnel outlet. In this manner by exploiting the kinetic energy of the liquid, an acceleration of the suspension toward the inlet of the cleaning device can be effectuated. The liquid discharged by the delivery nozzle(s) directly into the funnel outlet then guides the plastic particles into the funnel outlet. In so doing, a sufficient mixture of the plastic particles with the liquid can be achieved, possibly also without forming a swirl in the region of the mixing zone. This is further supported when the suspension generated in the delivery funnel is drawn by the subsequent cleaning device, for example when the pumping effect of the suspension pumped by the cleaning device generates a vacuum, or respectively suction at the outlet of the delivery funnel. Moreover, any clogs in the region of the funnel outlet can be thereby dissipated. The at least one rinsing nozzle is also connected to the liquid supply, for example via a pump. Of course, a combination of delivery nozzles directed toward the inner wall of the delivery funnel and into the funnel outlet is also possible.

At least the edge of the inlet of the delivery funnel can be elliptical according to another embodiment. The funnel itself can also be designed to elliptically taper. A particularly effective swirl formation is thereby achievable. However, other funnel shapes are also conceivable such as a circularly tapering cross-section, in particular when the distance between the funnel outlet and the inlet of the cleaning device is larger.

According to another embodiment, the supply for the plastic particles can comprise a supply reservoir containing the plastic particles and connected to the inlet of the delivery funnel, wherein rotatably driven supply brushes are arranged in the supply reservoir by which the plastic particles can be separately supplied to the inlet of the delivery funnel. By the for example two supply brushes that are for example rotatably driven about parallel rotary axes, the plastic particles located in the supply reservoir, that is for example also funnel-shaped, are supplied precisely separately and precisely dosed, in particular supplied like a curtain, to the delivery funnel. This can reliably further increase the throughput of the delivery funnel, even with a high solid consistency.

Moreover, a control apparatus can be provided that controls the supply for the plastic particles and/or the liquid supply. The amount of liquid required for the delivery according to the invention depends inter alia on the outlet of the cleaning device. When a pumping effect for an improved cleaning of the plastic particles is to be achieved in the cleaning device and a pump is located at the outlet of cleaning device, a correspondingly larger amount of liquid must be sprayed in so as to generate a pumpable suspension. If in contrast, the suspension is discharged freely from the outlet of the cleaning device, i.e., without a pump, a correspondingly slighter amount of liquid is adjusted so that the expenditure of resources and energy can be optimized. In combination with a jet pump refiner, the amount of liquid can be optimized for the cleaning in the cleaning device (with a minimal energy expenditure), and then a sufficient amount of liquid can be added to the cleaning device for transportation. By means of the control apparatus, the solid consistency supplied to the cleaning device can always be adjusted in the desired manner.

Moreover, a regulating apparatus can be provided that controls the supply for the plastic particles and/or the liquid supply on the basis of measured data provided by at least one measuring device. The measuring device can for example comprise a level sensor that measures the fill level in the outlet of the delivery funnel. In this embodiment, for example the fill level in the region of the funnel outlet, the supply of the plastic particles and/or the liquid can be controlled in the manner required depending on relevant measured data. Accordingly for example, a target fill level in the funnel outlet can be regulated that always ensures safe and reliable operation of the device according to the invention.

The invention moreover relates to a cleaning device to remove impurities from plastic particles with an inlet for jointly delivering plastic particles and a liquid, comprising a device according to the invention. The cleaning device can for example be designed as described in WO 2013/010654 A2 or WO 2014/111412 A1.

The method according to the invention can be carried out by the device according to the invention.

### BRIEF DESCRIPTION OF THE DRAWINGS

One exemplary embodiment of the invention is explained below in greater detail with reference to figures. Schematically:

FIG. 1 shows a sectional view of an embodiment of a cleaning device for removing impurities from plastic particles configured to jointly deliver plastic particles and a liquid;

FIG. 2 shows a perspective view of an embodiment of a delivery funnel of the device shown in FIG. 1;

FIG. 3 shows a first side view of the delivery funnel from FIG. 2;

FIG. 4 shows a second side view of the delivery funnel from FIG. 2; and

FIG. 5 shows a plan view of the delivery funnel from FIG. 2.

If not otherwise specified, the same reference numbers indicate the same objects in the figures.

### DETAILED DESCRIPTION OF THE INVENTION

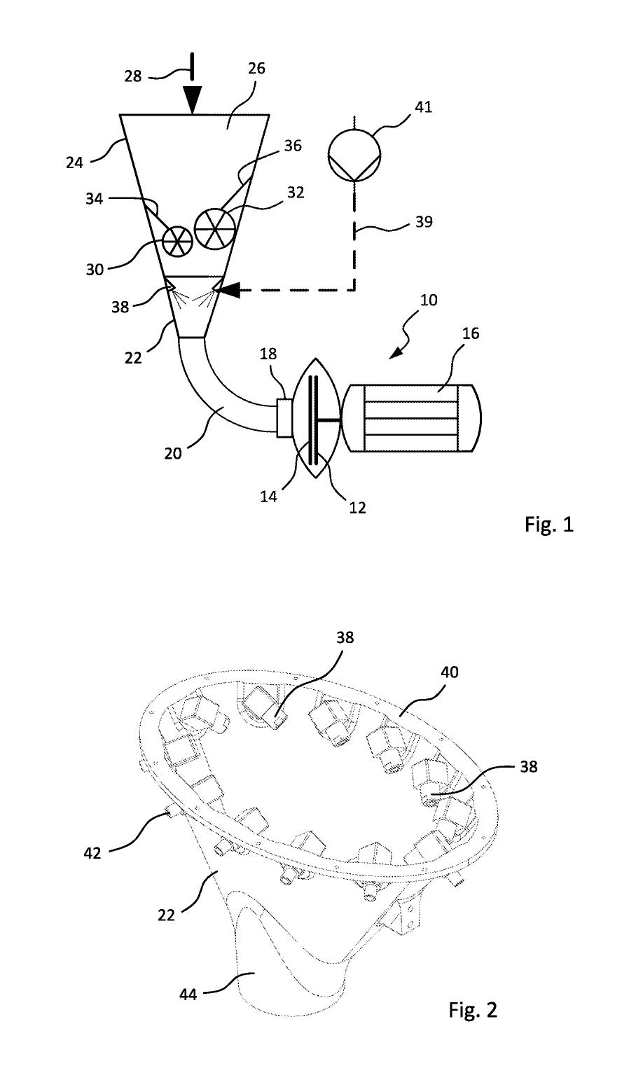

In FIG. 1, a cleaning device is shown at reference sign 10 for removing impurities from plastic particles, such as from plastic flakes. In the shown example, the cleaning device is a disk refiner whose cleaning discs are represented at reference signs 12 and 14. At least one of the cleaning discs 12, 14 is rotatably driven by a motor 16. Such a device is known per se and can for example be designed as shown in WO 2013/010654 A2. Although a disk refiner is portrayed in FIG. 1, other cleaning devices are also possible, such as a drum, or respectively ball refiner.

A pipeline 20 is connected to the inlet 18 of the cleaning device 10 and is joined to the outlet of a delivery funnel 22. A supply funnel 24 is arranged above the inlet of the delivery funnel 22 and forms a supply reservoir 26 into which plastic particles to be cleaned are added as illustrated by the arrow 28. In the portrayed example, two different size supply brushes 30, 32 that are rotatably driven about parallel rotary axes are located in the supply funnel 24. The plastic particles are supplied under gravity from the supply reservoir 26 via guide walls 34, 36 to the supply brushes 30, 32 and are guided between these into the inlet of the delivery funnel 22. In so doing, the plastic particles are separated and fall curtain-like evenly into the delivery funnel 22. A plurality of delivery nozzles 38 are arranged in the delivery funnel 22 as will be explained in greater detail with reference to FIGS. 2 to 5. The delivery nozzles 38 are connected by a supply line 39 and a pump 41 to a liquid supply (not shown), in the present case a water supply. Water supplied from this water supply is discharged by the delivery nozzles 38 into the delivery funnel 22.

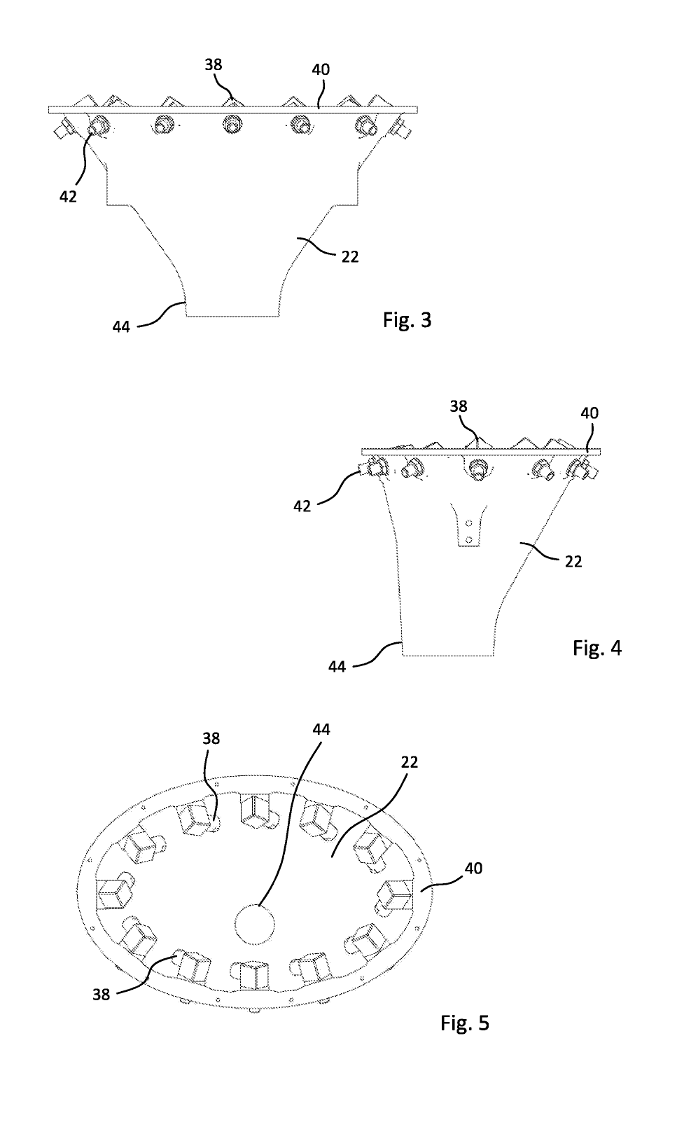

As in particular discernible in FIGS. 2 to 5, the delivery nozzles 38 are arranged distributed at regular intervals on the edge 40 of the inlet of the delivery funnel 22. In this case, a liquid connection 42 of the delivery nozzles 38 extends outwardly through the wall of the delivery funnel 22. The supply line 39 is connected to these liquid connections 42. The liquid jet discharged by the delivery nozzles 38 is directed toward the inner wall of the delivery funnel 22, in the present case at an angle relative to the axial direction of the delivery funnel that for example runs vertically from top to bottom in FIG. 3. The angle can for example lie within a range of 60° to 70° to the axial direction. In addition, the liquid jets discharged by the delivery nozzles 38 are each at a slight angle, for example less than 20°, to an imaginary tangent touching the opening edge 40 of the funnel inlet in the region of the attachment of the delivery nozzles 38. By means of this arrangement of the delivery nozzles 28, the sprayed-in water runs down helically on the inner wall of the delivery funnel 22 toward the outlet 44 of the delivery funnel 22, and a vortex, or respectively a swirling of the sprayed-in water occurs in the region of the outlet 44. This in turn leads to the formation of a mixing zone in the region of the outlet 44 in which the plastic particles falling under gravity over the supply brushes 30, 32 into the delivery funnel 22 are homogeneously mixed with the water and with a precisely defined solid component. The suspension of water and plastic particles formed in this manner is supplied via the supply line 20 to the inlet 18 of the cleaning device 10, and the plastic particles are freed of impurities in the cleaning device 10. In particular in FIGS. 2 and 5, it is moreover discernible that the edge 40 of the inlet of the delivery funnel 22 is designed elliptically.

Although not portrayed in the figures, at least one rinsing nozzle can also be arranged on the delivery funnel 22, alternatively or in addition to the shown delivery nozzles 38, through which a directed liquid jet can be discharged directly into the outlet 44 of the delivery funnel 22. Also, the device according to the invention can comprise a regulating apparatus that, on the basis of measured data from a measuring device, controls the supply for the plastic particles, in particular the rotary speed of the supply brushes 30, 32, and/or the supply of liquid, in particular the pump 41. The measuring device can for example measure the fill level in the outlet 44 of the delivery funnel 22.

### LIST OF REFERENCE SIGNS

10 Cleaning device
12 Cleaning disk
14 Cleaning disk
16 Motor
18 Inlet
20 Pipeline
22 Delivery funnel
24 Supply funnel
26 Supply reservoir
28 Arrow
30 Supply brush
32 Supply brush
34 Guide wall
36 Guide wall
38 Delivery nozzle
39 Supply line
40 Edge
41 Pump
42 Liquid connection
44 Outlet

1-23. (canceled)

24. A device for jointly delivering plastic particles and a liquid to a cleaning device to remove impurities from the plastic particles, the device comprising:
a delivery funnel comprising an inlet and an outlet, wherein the inlet is configured to connect to a supply for the plastic particles, and the outlet is configured to connect to the cleaning device; and
at least one delivery nozzle positioned on the delivery funnel that is configured to connect to a liquid supply, the at least one delivery nozzle is configured to discharge at least one liquid jet into the delivery funnel, wherein a position of the at least one delivery nozzle promotes mixing of the supplied plastic particles and the liquid in the delivery funnel.

25. The device according to claim 24, wherein the at least one delivery nozzle is positioned on the delivery funnel to create a swirl of liquid that mixes the plastic particles supplied to the delivery funnel, wherein the swirl of liquid is located in a region of the outlet of the delivery funnel.

26. The device according to claim 24, wherein the at least one liquid jet is directed toward an inner wall of the delivery funnel at an angle relative to an axial direction of the delivery funnel.

27. The device according to claim 24, wherein the at least one delivery nozzle is positioned on an edge of the inlet of the delivery funnel.

28. The device according to claim 24, wherein the at least one delivery nozzle is configured to be adjustable to change a direction of the at least one liquid jet.

29. The device according to claim 24, wherein the at least one liquid jet is discharged by the at least one delivery nozzle directly into the outlet of the delivery funnel.

30. The device according to claim 24, wherein the inlet of the delivery funnel comprises an elliptical edge.

31. The device according to claim 24, wherein the supply for the plastic particles comprises a supply reservoir connected to the inlet of the delivery funnel, and wherein rotatably driven supply brushes are positioned within the supply reservoir and are configured to push plastic particles to the inlet of the delivery funnel.

32. The device according to claim 31, further comprising a control apparatus configured to control the supply of at least one of the plastic particles and the liquid.

33. The device according to claim 32, further comprising at least one measuring device configured to measure and transmit data for at least one parameter of the device.

34. The device according to claim 33, further comprising a regulating apparatus configured to receive measured data from the at least one measuring device and control the supply of at least one of the plastic particles and the liquid based on the measured data.

35. The device according to claim 33, wherein the at least one measuring device comprises a fill level sensor configured to measure a fill level in the outlet of the delivery funnel.

36. A cleaning device for removing impurities from plastic particles and having an inlet for jointly delivering plastic particles and a liquid, the cleaning device comprising:
a delivery funnel comprising an inlet and an outlet, wherein the inlet is configured to connect to a supply for the plastic particles, and the outlet is configured to connect to the inlet of the cleaning device; and
at least one delivery nozzle positioned on the delivery funnel that is configure to connect to a liquid supply, the at least one delivery nozzle is configured to discharge at least one liquid jet into the delivery funnel, wherein a position of the at least one delivery nozzle promotes mixing of the supplied plastic particles and the liquid in the delivery funnel

37. The cleaning device according to claim 36, wherein the cleaning device is one of a refiner and a drum.

38. A method for jointly delivering plastic particles and a liquid into a cleaning device for removing impurities from the plastic particles, the method comprising:
supplying plastic particles to an inlet of a delivery funnel;
supplying liquid to at least one delivery nozzle;
discharging at least one liquid jet from the at least one delivery nozzle into the delivery funnel to mix the supplied plastic particles with the liquid, wherein the mixing occurs in the delivery funnel;
discharging the mixture of the plastic particles and the liquid from an outlet of the delivery funnel and into an inlet of the cleaning device.

39. The method according to claim 38, wherein the at least one liquid jet is discharged into the delivery funnel to create a swirl of liquid that mixes the supplied plastic particles with the liquid in a region of the outlet of the delivery funnel.

40. The method according to claim 38, wherein the at least one liquid jet is directed toward an inner wall of the delivery funnel at an angle relative to an axial direction of the delivery funnel.

41. The method according to claim 38, wherein the at least one liquid jet is discharged directly into the outlet of the delivery funnel.

42. The method according to claim 38, wherein the plastic particles are supplied from a supply reservoir containing plastic particles, and wherein the supply reservoir is configured to connect to the inlet of the delivery funnel and further comprises rotatably driven supply brushes configured to guide the plastic particles into the inlet of the delivery funnel.

43. The method according to claim 38, further comprising at least one measuring device configured to measure data pertaining to at least one parameter of the method, wherein the supply of at least one of the plastic particles and the liquid of the at least one delivery nozzle is controlled based on the measured data.

44. The method according to claim 43, wherein the at least one measuring device is configured to measure a fill level in the outlet of the delivery funnel.

45. A device configured to perform the method according to claim 38.
